(19) United States
(12) Patent Application Publication
(10) Pub. No.: US 2020/0273311 A1
(43) Pub. Date: Aug. 27, 2020

(54) Movement Notification System

(71) Applicant: Donovan Illig, Prince George (CA)

(72) Inventor: Donovan Illig, Prince George (CA)

(21) Appl. No.: 16/282,693

(22) Filed: Feb. 22, 2019

(51) Int. Cl. G08B 21/02; H04W 4/44; G08B 5/36; G08B 3/10; G08B 6/00

(52) U.S. Cl. CPC G08B 21/02; H04W 4/44; G08B 6/00; G08B 3/10; G08B 5/36

(57) ABSTRACT

A movement notification system having an equipment device that is affixed to a piece of equipment and a worker device that is affixed to a worker. The equipment device is configured to detect movement of the piece of equipment and is also configured to transmit a movement detection signal upon the detection of movement of the piece of equipment. The worker device is configured to receive the movement detection signal and is also configured to provide a movement notification to the worker upon receipt of the movement detection signal.

### REFERENCE TO PENDING APPLICATIONS

This application does not claim the benefit of any issued U.S. Patent or pending application.

### BACKGROUND OF THE INVENTION

### Field of the Invention

The present invention generally relates to work place safety, and more specifically, to a system to notify a worker when a piece of equipment is in motion.

### Background

In the workplace, moving equipment and vehicles create a risk of injury and death to workers. This risk is increased by human error and other limitations, such as distractions, fatigue, loss of focus, poor visibility, etc. Most industrial settings require workers to operate in loud environments, which can cause the workers to have difficulty hearing equipment or vehicles in motion; especially if they wear hearing protection. For example, in a train yard, conductors will often shove a train car and release it down a track that workers are operating near. The train car rolls down the track completely uncontrolled until it connects with another car down the line. These train cars can make very little noise as the roll down the track. This can cause a worker to not be aware of the moving train car until the train car is only feet away from the worker. If a worker is looking way from the tracks, he may not notice the moving train car until it is upon him which increases the risk of injury.

Accordingly, there is a need for a service which can satisfy the need set out above.

### BRIEF SUMMARY OF THE INVENTION

According to an aspect of the present invention, a system to notify a worker when a vehicle, piece of equipment or component thereof, such as a crane boom, is in motion.

In one aspect, a movement notification system is disclosed. The system includes an equipment device affixed to a piece of equipment and a worker device affixed to a worker. The equipment device is configured to detect movement of the piece of equipment and is also configured to transmit a movement detection signal upon the movement of the piece of equipment. The worker device is configured to receive the movement detection signal and is also configured to provide a movement notification to the worker upon the receipt of the movement detection signal.

The movement notification may be an audible notification, such as beeping sound, a visual notification, such as flashing light, and/or a vibration notification, such as a vibration notice.

In some aspects, the equipment device may include a movement detection component that is configured to detect movement the piece of equipment. The equipment device may also include a transmitter that is configured to transmit the movement detection signal upon the detection of movement of the piece of equipment by the movement detection component.

In some aspects, the worker device may include a receiver that is configured to receive the movement detection signal. The worker device may also include a notification component configured to provide movement notification to the worker upon the reception of the movement detection signal by the receiver.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 schematic block diagram of a system in accordance with embodiments of the present invention.

FIG. 2 schematic block diagram of a system in accordance with embodiments of the present invention.

FIG. 3 is a flow diagram of embodiment of a worker device of the present invention.

FIG. 4 is a flow diagram of embodiment of a worker device of the present invention.

### DETAILED DESCRIPTION FO THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be used including hard disks, CD-ROMs, optical storage devices, a transmission media such as those supporting the Internet or an intranet, or magnetic storage devices.

Computer program code for carrying out operations of the present invention may be written in an object-oriented programming language, such as Java® or C++. However, the computer program code for carrying out operations of the present invention may also be written in conventional procedural programming languages, such as the “C” programming language or assembly language. The program code may execute entirely on the user's computer, partly on the user's computer, as a stand-alone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Embodiments of the present invention will now be described with respect to the figures. Embodiments of the present invention provide methods, systems and/or computer program products for the notification of movement of a piece of equipment to a worker in order to reduce injury thereof.

The present invention is directed to a system that may drastically reduce the risk of incidents caused by human error and limitations, such as distractions, fatigue, loss of focus, poor visibility, inability to hear, etc., and provide a new level of safety and awareness for employees exposed to risk of being struck by vehicles or moving equipment. The present invention may include one or more equipment devices and worker devices. The equipment device may be permanently installed on the vehicle/equipment, or manually applied temporarily by workers in the field while the vehicle or equipment is to be in use. When the equipment device is turned on, it defaults to “standby” mode. Once the piece of equipment begins to move, a movement detection signal is transmitted from the equipment device.

Once the movement detection signal has begun to be transmitted, a worker device worn by the employees within proximity, or range, of the piece of equipment will receive the signal and provide a notification of such movement. The proximity, or range, of the signal may be dependent upon one or more various factors, such as the type of equipment. The notification may be one or more of various types of notifications, such as audible, visual or tactile, including vibration, an audible alarm/indicator and flashing lights.

Upon receipt of the movement notification signal, the worker may acknowledge the movement by pressing the designated button on the worker device, which may terminate one or more notifications. The button may be on the top, front or sides of the worker device.

For example, when a movement notification signals is acknowledged, an audible alarm and vibration may be terminated, while a flashing light may not be terminated until after the movement of the piece of equipment stops or the worker leaves the range of the piece of equipment, or the piece of equipment leaves range of the worker. The present invention allows the worker to be aware of the on-going movement and also helps to add visibility to the worker in dark conditions.

Further, the sensitivity of a worker device may be modified to reduce and/or prevent redundant or unnecessary alarms. For example, if a movement is acknowledged and a subsequent movement is detected, the alarm resets and the new movement must be acknowledged by pressing the button again.

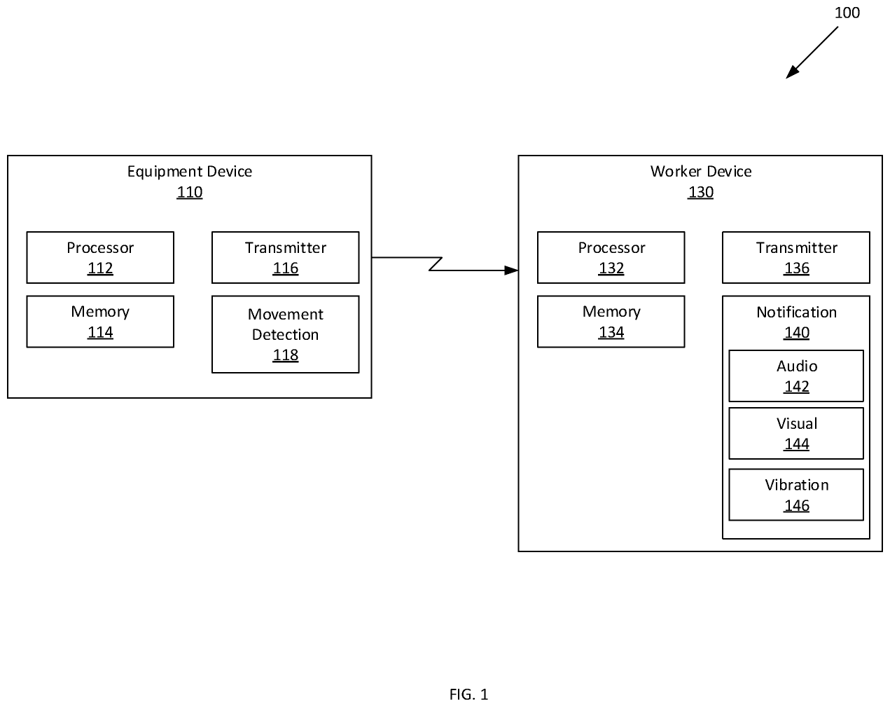

As illustrated in FIG. 1, an embodiment of a movement notification system 100 is disclosed. System 100 includes an equipment device 110 and a worker device 130. While this embodiment includes a single equipment device 110 and a single worker device 130, those skilled in the art will recognize that the system of the present invention may include a plurality of equipment devices and/or a plurality of worker devices.

In this embodiment, equipment device 110 may be affixed to a piece of equipment. Equipment device 110 may include a processor 112, a memory 114, a movement detection component 118 and a transmitter 116. Movement detection component 118 is configured to detect movement of the piece of equipment upon which such is affixed.

In some embodiments, the movement detection component 118, in combination with processor 112 may electronically detect movement of the piece of equipment. In these embodiments, movement detection component 118 may include at least one sensor that can detect optical and/or acoustic changes in the position of the piece of equipment. Infrared light, laser, sound, vibration, radio frequency energy and/or magnetic technologies may also be utilized. In other embodiments, the movement detection component 118 may be in communication with a location determination system such as the global position system (GPS). In some embodiments, the movement detection component 118 may be directly connected to the piece of equipment, such as the transmission, drive train or other movement elements of the piece of equipment, to detect the mechanical movement of the piece of equipment.

The transmitter 116 is configured to transmit a notification signal 120 upon the detection of movement of the piece of equipment by the movement detection component 118. Memory 114 is configured to store instructions regarding the operation of equipment device 110. Processor 112 is configured to carry out the tasks relating to the operation of the equipment device 110 according to the stored instructions, including being in communication with, and providing actions to take to, all remaining components of the equipment device 110.

In this embodiment, the worker device 130 is affixed to a worker. Worker device 130 includes a processor 132, memory 134, receiver 136 and a notification component 140. Receiver 136 is configured to receive the movement detection signal 120 that has been transmitted from the equipment device 110. Notification component 140 is configured to provide a movement notification to the worker upon the receipt of the movement detection signal 120. Notification component may be, but not limited to, at least one speaker that can produce sound, at least one light, such as a light emitting diode (LED) light, and/or at least one tactile device that can move or vibrate. In some embodiments, the notification may be audible notification, such as a beeping noise, visual notification, such as a blinking light, and/or vibration notification. In these embodiments, any visual notification, i.e. a flashing light, would not be turned off by such acknowledgement, and would only turn off once the movement detection signal 120 has been transmitting from the equipment device 110. Memory 134 is configured to store instructions regarding the operation of the worker device 130. Processor 132 is configured to carry out the tasks relating to the operation of the worker device 130 according to the stored instructions, including being in communication with, and providing actions to take to, all remaining components of the worker device 130.

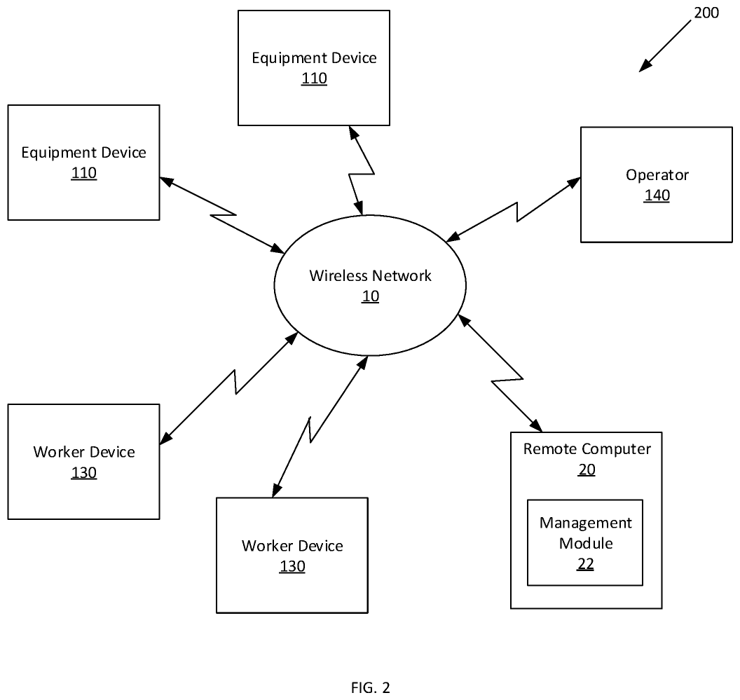

In some embodiments, as illustrated in FIG. 2, the movement notification system 200 may be connected through a wireless network 10. In these embodiments, multiple equipment devices 110 and multiple worker devices 130 may be in communication through wireless network 10. This can allow for a user to receive movement detection signals 120 from multiple equipment devices 110.

Further, in these embodiments, the movement notification system 200 may have various modes of operation. These modes may include providing a notification signal 120 to an operator 140 or other third party to allow for monitoring of the notification signal 120 in order to reduce and/or prevent redundant or unnecessary alerts. Examples may include: alerts of movement from specific pieces of equipment may be inhibited to specific wearable receivers, and operators may be alerted of the presence of workers nearby. Another example of various modes of operation I involves an operator of loader. In one mode, the operator may receive an alert when the loader sends an alert to someone on the ground to notify the operator that a worker is nearby but may not send a movement alert only to the operator as the operator is aware of the movement of the loader. In an additional mode, the workers on the ground in constant close proximity to a piece of equipment may one audible alert and continuous visual alerts from that specific piece of equipment. This makes the worker aware of the movement of the piece of equipment without having unnecessary audible alerts.

Further, in these embodiments, a remote computer 20 having a management module 22 may be in communication with the wireless network 10 to allow for the management of the movement notification system 200. The remote computer 20 may be any type of computer, include, but not limited to, a server, and may be located in any type of configuration, including, but not limited to, a laptop computer, tablet, and a mobile application on a smart phone. Management module 22 allows the activities, i.e. start and ending of a movement signal 120 from an equipment device 110, acknowledgements of the movement signal 120, and locations and speed of both the equipment device 110 and worker device 130, of the various devices of movement notification system 200 to be tracked and recorded. This allows for management oversight and monitoring of movement notification system 200.

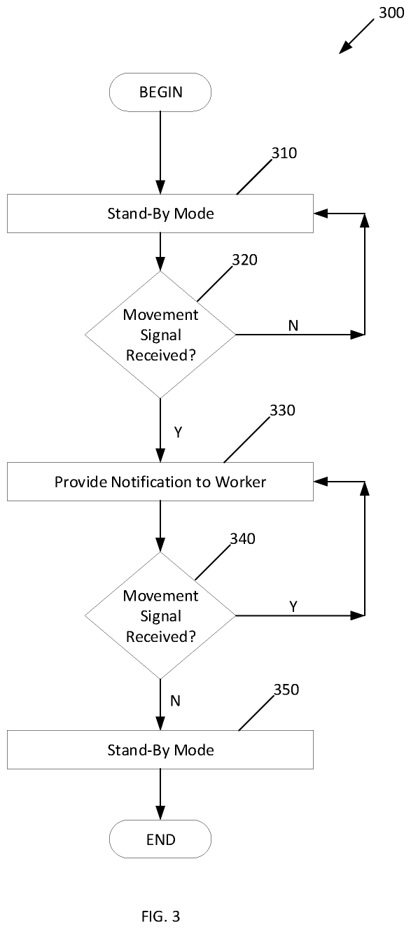

As illustrated in FIG. 3, an embodiment of a method 300 of the operation of an embodiment of a worker device 130 is disclosed. In this embodiment, a worker device 130 is turned on and enters a stand-by mode (block 310). Worker device 130 determines, through receiver 136, if a movement signal 120 has been received (block 320). If no signal is received, worker device 130 stays in stand-by mode. If a signal is received, a movement notification through movement notification component 138 is provided to a worker (block 330). Worker device 130 then continues to determine if the same movement signal 120 or a different movement signal have been received (block 340). If a movement signal 120 is received, the notification is continued to be provided to the worker. If no additional movement signal 120 is received, worker device 130 is returned to stand-by mode (block 350).

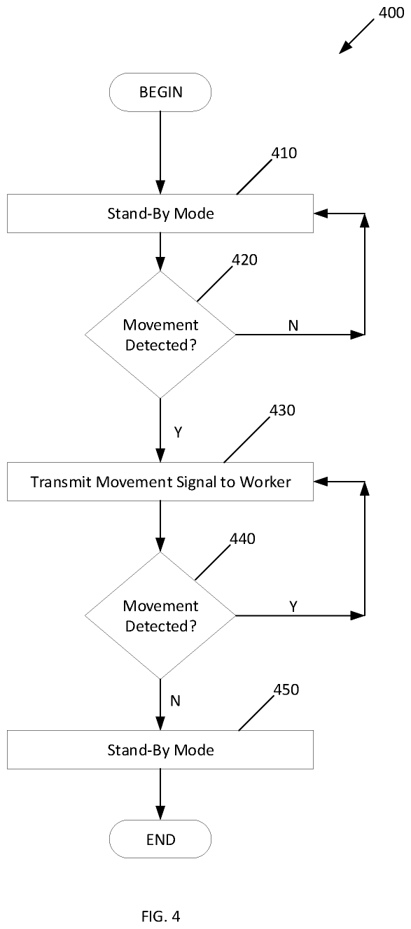

As illustrated in FIG. 4, an embodiment of a method 400 of the operation of an embodiment of an equipment device 110 is disclosed. In this embodiment, an equipment device 110 is turned on and enters a stand-by mode (block 410). Equipment device 110 determines, through movement detection component 118, if there is movement of the associated piece of equipment (block 420). If no movement is detected, equipment device 110 stays in stand-by mode. If a movement is determined, a signal of movement 120 is sent, and otherwise transmitted, by transmitter 116 (block 430). Equipment device 110 then continues to determine if there is movement of the piece of equipment (block 440). If the detection of movement continues, the transmission of movement signal 120 continues. If no movement of the piece of equipment is detected, equipment device 110 is returned to stand-by mode (block 450).

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

1. A movement notification system comprising:
an equipment device affixed to a piece of equipment, the equipment device having
at least one processor, and a non-transitory computer readable storage medium having computer readable instructions stored thereon for execution by the processor, causing the processor to carry out the tasks relating to the operation of the equipment device,
a movement detection component configured to detect movement of the piece of equipment, and
a transmitter configured to transmit a movement detection signal upon the detection of movement of the piece of equipment by the movement detection component; and
a worker device affixed to a worker, the worker device having
at least one processor, and a non-transitory computer readable storage medium having computer readable instructions stored thereon for execution by the processor, causing the processor to carry out the tasks relating to the operation of the worker device,
a receiver configured to receive the movement detection signal; and
a notification component configured to provide at least one movement notification to the worker upon the reception of the movement detection signal by the receiver.

2. The movement notification system of claim 1, wherein the movement notification is an audible notification.

3. The movement notification system of claim 1, wherein the movement notification is a visual notification.

4. The movement notification system of claim 1, wherein the movement notification is a vibration notification.

5. The movement notification system of claim 1, wherein movement detection component comprises at least one sensor that can detect optical changes in the position of the piece of equipment.

6. The movement notification system of claim 1, wherein a notification component comprises at least one speaker configured to provide sound, at least one light, such as a light emitting diode (LED) light, and/or at least one tactile device that can move or vibrate.

7. The movement notification system of claim 1, wherein a notification component comprises at least one light source.

8. The movement notification system of claim 1, wherein a notification component comprises at least one tactile device that can move or vibrate.

9. The movement notification system of claim 1, wherein the worker device further comprises a notification shut off component configured to allow the worker to shut of at least one of the movement notifications.

10. The movement notification system of claim 1, wherein a notification component comprises at least one speaker configured to provide sound, at least one light, such as a light emitting diode (LED) light, and at least one tactile device that can move or vibrate, wherein the movement notification is a combination of an audible notification, a visual notification and a vibration notification.

11. The movement notification system of claim 10, wherein the worker device further comprises a notification shut off component configured to allow the worker to shut of at least one, but not all, of the movement notifications.

12. The movement notification system of claim 10, wherein the worker device further comprises a notification shut off component configured to allow the worker to shut of the audible notification and vibration notification but not the visual notification.

13. The movement notification system of claim 1, wherein the transmitter is configured to transmit the movement detection signal over a wireless network, and the receiver is configured to receive the movement detection signal over the wireless network.

14. The movement notification system of claim 13, further comprising a remote computer having a management module, the remote computer being in communication with the wireless network and configured to receive the movement detection signal to allow for the management of the movement notification system.

15. A method to provide movement notification comprising:
affixing an equipment device to a piece of equipment;
determining movement, by the equipment device, of the piece of equipment;
transmitting by the equipment device, upon determining of movement, a signal of movement;
affixing a worker device to a worker;
determining by the worker device whether a signal of movement has been received; and
providing by the worker device, upon determination of the receipt of the signal of movement, a movement notification to the worker.
